(19) United States
(12) Patent Application Publication
(10) Pub. No.: US 2014/0168595 A1
(43) Pub. Date: Jun. 19, 2014

(54) LIQUID CRYSTAL COMPOSITION AND LIQUID CRYSTAL DISPLAY DEVICE INCLUDING THE SAME

(71) Applicant: Electronics and Telecommunications Research Institute, Daejeon (KR)

(72) Inventors: Gi Heon KIM, Daejeon (KR); Hojun RYU, Seoul (KR)

(21) Appl. No.: 13/909,183

(22) Filed: Jun. 4, 2013

(30) Foreign Application Priority Data
Dec. 13, 2012 (KR) 10-2012-0145547

(51) Int. Cl. C09K 19/44

(52) U.S. Cl. CPC C09K 19/44
USPC 349/182

(57) ABSTRACT

A liquid crystal display device may include a liquid crystal and a coloring material including at least one of yellow, magenta, and cyan coloring materials. The coloring material may have high solubility and dispersion stability on the liquid crystal, and thus, it can be used for a liquid crystal layer. The liquid crystal display device may include a partition delimiting pixels, and the liquid crystal layer may be provided in the pixels. The pixels may include first, second, and third pixels. The coloring materials in the first, second, and third liquid crystal layers may be adjusted, in terms of kind, composition, and weight percentage, to control colors to be displayed by the first, second, and third pixels.

### CROSS-REFERENCE TO RELATED APPLICATIONS

This U.S. non-provisional patent application claims priority under 35 U.S.C. §119 to Korean Patent Application No. 10-2012-0145547, filed on Dec. 13, 2012, in the Korean Intellectual Property Office, the entire contents of which are hereby incorporated by reference.

### BACKGROUND OF THE INVENTION

Example embodiments of the inventive concept relate to a liquid crystal display device, and in particular, to a guest-host-type liquid crystal display device.

A liquid crystal display device is one of most-widely used flat-panel display devices, and includes two substrates, on which a pixel electrode and a common electrode are provided, and a liquid crystal layer interposed therebetween. Electric field to be applied to the liquid crystal layer may be controlled by adjusting voltages applied to the pixel and common electrodes. The control of the electric field makes it possible to change orientation of liquid crystal molecules in the liquid crystal layer and thereby to control polarization of an incident light.

A guest-host-type liquid crystal display device may include a liquid crystal serving as a host and a dichroism coloring material serving as a guest. The dichroism coloring material may be used to control transmittance of light. The coloring material may affect stability of the liquid crystal. For example, the coloring material may decompose the liquid crystal or change viscosity of the liquid crystal and so forth. Accordingly, only a few coloring materials can be restrictively used for the liquid crystal display device. The coloring material for the liquid crystal display device is needed to have high solubility on the liquid crystal, high absorption property, and high dye order parameter, without ion group or a group capable of being ionized by electric field.

### SUMMARY

Example embodiments of the inventive concept provide a liquid crystal composition exhibiting high solubility on liquid crystal and high dichroism.

Other example embodiments of the inventive concept provide a liquid crystal display device capable of displaying various colors with low power consumption.

According to example embodiments of the inventive concepts, a liquid crystal display device may include a lower substrate on a reflection plate, an upper substrate spaced apart from and facing the lower substrate, and a liquid crystal layer interposed between the lower substrate and the upper substrate. The liquid crystal layer may include a liquid crystal, and a coloring material including at least one of yellow, magenta, and cyan coloring materials that may be represented by the following chemical formulas 1, 2, and 3, respectively,

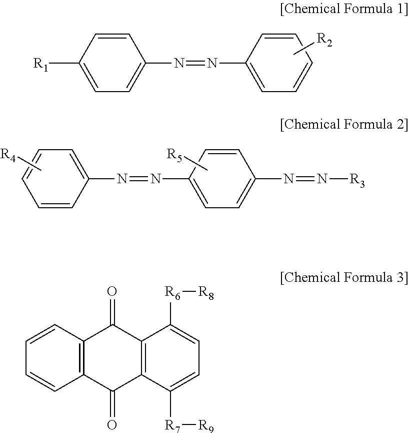

where R₁ may be one selected from the group consisting of —N(CH₃)₂, —N(C₂H₅)₂, and —NR₂ (here, R may be an alkyl chain having 1 to 5 carbon atoms), R₂ may be one selected from the group consisting of H, CH₃, C₂H₅, linear alkyl having 1 to 5 carbon atoms, branched alkyl having 1 to 5 carbon atoms, linear alkene having 1 to 5 carbon atoms, branched alkene having 1 to 5 carbon atoms, aromatic functional group having 1 to 3 benzene rings, and naphthalene, R₃ may be one selected from the group consisting of the following structural units:

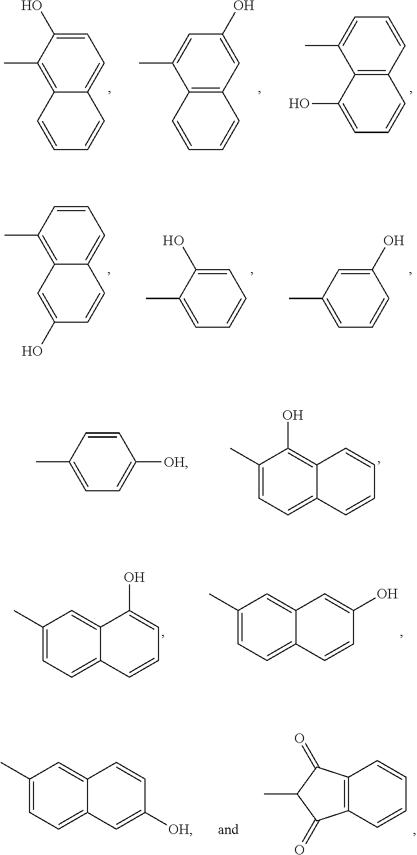

each of R₄ and R₅ may be one selected from the group consisting of H, CH₃, C₂H₅, linear alkyl having 1 to 5 carbon atoms, branched alkyl having 1 to 5 carbon atoms, linear alkene having 1 to 5 carbon atoms, branched alkene having 1 to 5 carbon atoms, aromatic functional group having 1 to 3 benzene rings, and naphthalene, each of R₆ and R₇ may be one selected from the group consisting of O, S, Se, CH₂, NH, and COO, and each of R₈ and R₉ may be one selected from the group consisting of H, CH₃, C₂H₅, C₃H₈, C₄H₁₁, C₅H₁₄, linear alkyl having 6 to 10 carbon atoms, branched alkyl having 6 to 10 carbon atoms, linear alkene having 1 to 5 carbon atoms, branched alkene having 1 to 5 carbon atoms, aromatic functional group having 1 to 3 benzene rings, and naphthalene.

In example embodiments, the liquid crystal display device may further include a partition provided on the lower substrate to delimit a first pixel, a second pixel, and a third pixel. The liquid crystal layer may include a first liquid crystal layer provided on the first pixel, a second liquid crystal layer provided on the second pixel, and a third liquid crystal layer provided on the third pixel.

In example embodiments, the first pixel, the second pixel, and the third pixel may be configured to display different colors from each other.

In example embodiments, the first liquid crystal layer may include the yellow coloring material, the second liquid crystal layer may include the magenta coloring material, and the third liquid crystal layer may include the cyan coloring material.

In example embodiments, the first liquid crystal layer may include at least two of the yellow, magenta, and cyan coloring materials, the second liquid crystal layer may include at least two of the yellow, magenta, and cyan coloring materials, whose composition may be different from that of the first liquid crystal layer, and the third liquid crystal layer may include at least two of the yellow, magenta, and cyan coloring materials, whose composition may be different from that of the first liquid crystal layer.

In example embodiments, the first liquid crystal layer may include at least two of the yellow, magenta, and cyan coloring materials, the second liquid crystal layer may include at least two of the yellow, magenta, and cyan coloring materials, whose weight-percent ratio may be different from that of the first liquid crystal layer, and the third liquid crystal layer may include at least two of the yellow, magenta, and cyan coloring materials, whose weight-percent ratio may be different from that of the second liquid crystal layer.

In example embodiments, the coloring material may be contained to have a weight percent of 0.01 to 10 wt % with respect to the liquid crystal.

According to other example embodiments of the inventive concepts, a liquid crystal display device may include a coloring material including at least one of a yellow coloring material represented by the following chemical formula 1, a magenta coloring material represented by the following chemical formula 2, and a cyan coloring material represented by the following chemical formula 3,

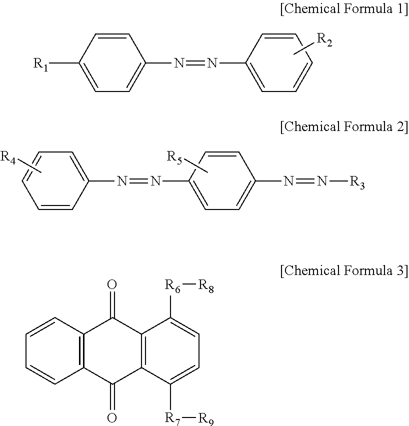

where R₁ may be one selected from the group consisting of —N(CH₃)₂, —N(C₂H₅)₂, and —NR₂ (here, R may be an alkyl chain having 1 to 5 carbon atoms), R₂ may be one selected from the group consisting of H, CH₃, C₂H₅, linear alkyl having 1 to 5 carbon atoms, branched alkyl having 1 to 5 carbon atoms, linear alkene having 1 to 5 carbon atoms, branched alkene having 1 to 5 carbon atoms, aromatic functional group having 1 to 3 benzene rings, and naphthalene, R₃ may be one selected from the group consisting of the following structural units:

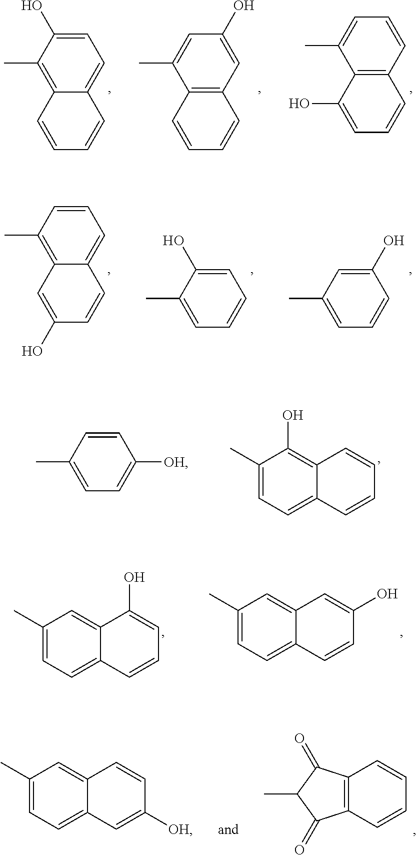

each of R₄ and R₅ may be one selected from the group consisting of H, CH₃, C₂H₅, linear alkyl having 1 to 5 carbon atoms, branched alkyl having 1 to 5 carbon atoms, linear alkene having 1 to 5 carbon atoms, branched alkene having 1 to 5 carbon atoms, aromatic functional group having 1 to 3 benzene rings, and naphthalene, each of R₆ and R₇ may be one selected from the group consisting of O, S, Se, CH₂, NH, and COO, and each of R₈ and R₉ may be one selected from the group consisting of H, CH₃, C₂H₅, C₃H₈, C₄H₁₁, C₅H₁₄, linear alkyl having 6 to 10 carbon atoms, branched alkyl having 6 to 10 carbon atoms, linear alkene having 1 to 5 carbon atoms, branched alkene having 1 to 5 carbon atoms, aromatic functional group having 1 to 3 benzene rings, and naphthalene.

In example embodiments, the liquid crystal display device may further include a liquid crystal that is contained to have a weight percent of 0.01 to 10 wt % with respect to the liquid crystal.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a sectional view of a liquid crystal display device according to example embodiments of the inventive concept.

FIG. 2 is a sectional view of a liquid crystal display device according to other example embodiments of the inventive concept.

FIG. 3 is a plan view of a liquid crystal display device according to other example embodiments of the inventive concept.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

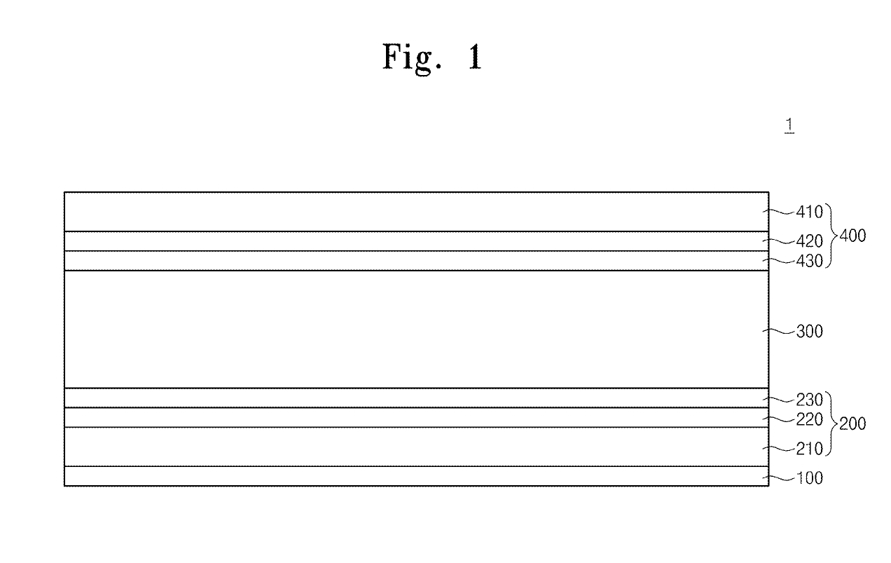

FIG. 1 is a sectional view of a liquid crystal display device according to example embodiments of the inventive concept.

Referring to FIG. 1, a liquid crystal display device 1 may include a reflection plate 100, a lower substrate 200 on the reflection plate 100, an upper substrate 400 spaced apart from the lower substrate 200, and a liquid crystal layer 300 provided between the lower substrate 200 and the upper substrate 400.

The reflection plate 100 may be at least one of a white plate, a mirror, or a dual brightness enhancement film (DBEF).

The lower substrate 200 may include a first substrate 210, a first electrode 220, and a first insulating layer 230. The first electrode 220 and the first insulating layer 230 may be sequentially stacked on the first substrate 210. The first substrate 210 may include a transparent material (e.g., glass or plastic material).

The first electrode 220 may include indium tin oxide (ITO), indium zinc oxide (IZO), silver nanowire, carbon nanotube, graphene, poly(3,4-ethylenedioxythiophene)-poly(styrenesulfonate) (PEDOT-PSS), polyaniline, polythiophene or any mixtures thereof. The first electrode 220 may be provided to have a first slit. For example, the first slit may be shaped like a linear pattern or a stripe pattern. The first electrode 220 may be connected to a transistor (not shown) to serve as, for example, a pixel electrode.

The first insulating layer 230 may be transparent. The first insulating layer 230 may be formed of an insulating material, thereby preventing an unintended electric short circuit from being produced in the liquid crystal layer 300. In example embodiments, the first insulating layer 230 may include an organic material (e.g., polyimide, polyacrilate, epoxy, polyvinyl alcohol, parylene, polystyrene, polyacetate, polyvinyl pyrrolidone, fluorine-based polymer, polyvinylchloride, or a compound containing at least one thereof). In other embodiments, the first insulating layer 230 may include an inorganic material (e.g., silicon oxide (SiO), silicon nitride (SiN), silicon oxynitride (SiON), silicon carbide (SiC), silicon oxycarbide (SiOC), or any combination thereof). The first insulating layer 230 may include a mixture of organic and inorganic materials.

The upper substrate 400 may be spaced, by a uniform or specific space, apart from the lower substrate 200. The upper substrate 400 may include a second insulating layer 430, a second electrode 420, and a second substrate 410. In example embodiments, the second electrode 420 and the second substrate 410 may be sequentially stacked on the second insulating layer 430.

The second insulating layer 430 may be transparent. The second insulating layer 430 may be formed of an insulating material, thereby preventing an unintended electric short circuit from being produced in the liquid crystal layer 300. The second insulating layer 430 may include an organic material, an inorganic material, or a mixture of organic and inorganic materials. The organic and inorganic materials for the second insulating layer 430 may be identical or similar to those for the first insulating layer 230 enumerated above.

The second electrode 420 may include the same or similar material as that for the first electrode 220. The second electrode 420 may be provided to have a second slit. For example, the second slit of the second electrode 420 may be provided at an angle to the first slit of the first electrode 220. For example, the second slit may be formed to cross the first slit. In example embodiments, the second electrode 420 may be applied with a voltage that is different from that applied to the first electrode 220. By applying a voltage to the first electrode 220 and/or the second electrode 420, an electric field may be produced through the liquid crystal layer 300.

In example embodiments, the first and second electrodes 220 and 420 may be disposed on the lower and upper substrates 200 and 400, respectively, but example embodiments of the inventive concepts may not be limited thereto. For example, the first and second electrodes 220 and 420 may be provided on one of the lower and upper substrates 200 and 400. Alternatively, the first and second electrodes 220 and 420 may be provided on the same layer or be separately provided on different layers with the first insulating layer 230 or the second insulating layer 430 interposed therebetween.

The second substrate 410 may include a transparent material (e.g., glass or plastic material).

The liquid crystal layer 300 may be interposed between the first insulating layer 230 and the second insulating layer 430. The liquid crystal layer 300 may include a liquid crystal composition, which may include a liquid crystal and a coloring material dissolved therein. The coloring material may be contained to have a weight percent of about 0.01 wt % to about 10 wt % with respect to the liquid crystal. The electric field may be utilized to control configuration of the liquid crystal and the coloring material in the liquid crystal layer 300. As the result, the liquid crystal display device 1 can display various colors.

The coloring material may contain an aromatic ring or a condensed ring. The coloring material may absorb or transmit incident light, depending on an incident direction thereof. Accordingly, the coloring material can display a specific color. The coloring material may have high dichroism. The coloring material may be interacted with the liquid crystal and have high solubility and dispersion stability on the liquid crystal in low temperature. Accordingly, the coloring material may be used as a constituent of the liquid crystal composition. The liquid crystal composition in the liquid crystal layer 300 may further include a reactivity monomer improving a cross-linking reaction between the liquid crystal and the coloring material. The coloring material may include at least one of a yellow coloring material, a magenta coloring material, a cyan coloring material, or any combination thereof.

The yellow coloring material may include two aromatic rings linked by an azo group and may be represented by the following chemical formula 1.

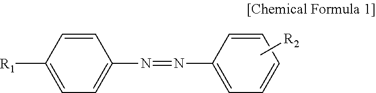

where R₁ is one selected from the group consisting of N(CH₃)₂, N(C₂H₅)₂, and NR₂ (here, R is an alkyl chain having 1 to 5 carbon atoms), and R₂ is one selected from the group consisting of H, CH₃, C₂H₅, linear alkyl having 1 to 5 carbon atoms, branched alkyl having 1 to 5 carbon atoms, linear alkene having 1 to 5 carbon atoms, branched alkene having 1 to 5 carbon atoms, aromatic functional group having 1 to 3 benzene rings, and naphthalene.

The magenta coloring material may be represented by the following chemical formula 2.

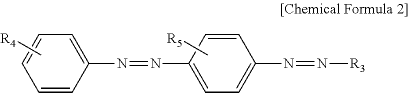

where R₃ is one selected from the group consisting of the following structural units:

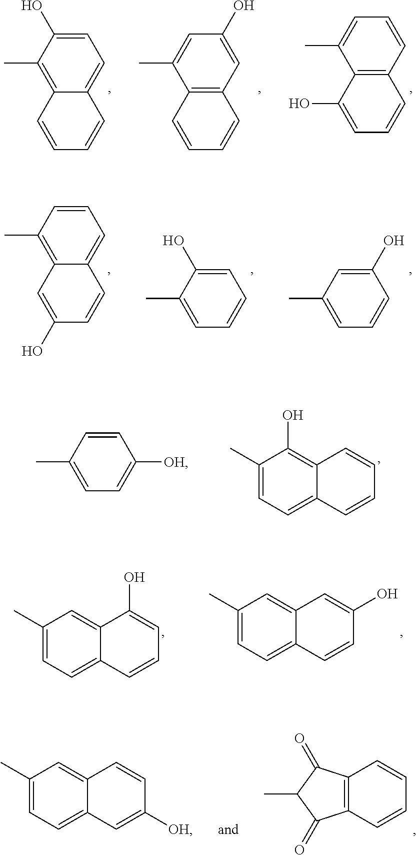

and each of R₄ and R₅ is one selected from the group consisting of H, CH₃, C₂H₅, linear alkyl having 1 to 5 carbon atoms, branched alkyl having 1 to 5 carbon atoms, linear alkene having 1 to 5 carbon atoms, branched alkene having 1 to 5 carbon atoms, aromatic functional group having 1 to 3 benzene rings, and naphthalene.

The cyan coloring material may be represented by the following chemical formula 3.

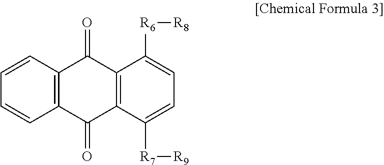

where each of R₆ and R₇ is one selected from the group consisting of O, S, Se, CH₂, NH, and COO, and each of R₈ and R₉ is one selected from the group consisting of H, CH₃, C₂H₅, C₃H₈, C₄H₁₁, C₅H₁₄, linear alkyl having 6 to 10 carbon atoms, branched alkyl having 6 to 10 carbon atoms, linear alkene having 1 to 5 carbon atoms, branched alkene having 1 to 5 carbon atoms, aromatic functional group having 1 to 3 benzene rings, and naphthalene.

Since the liquid crystal layer 300 contains one selected from the group consisting of the yellow, magenta, and cyan coloring materials, the liquid crystal layer 300 can display a color. In other embodiments, the liquid crystal layer 300 may be configured to include at least two selected from the group consisting of the yellow, magenta, and cyan coloring materials to display a mixed color. The kind, composition, and weight percentage of the coloring material in the liquid crystal layer 300 may be adjusted to control color coordinate, lightness, and saturation of a color to be displayed.

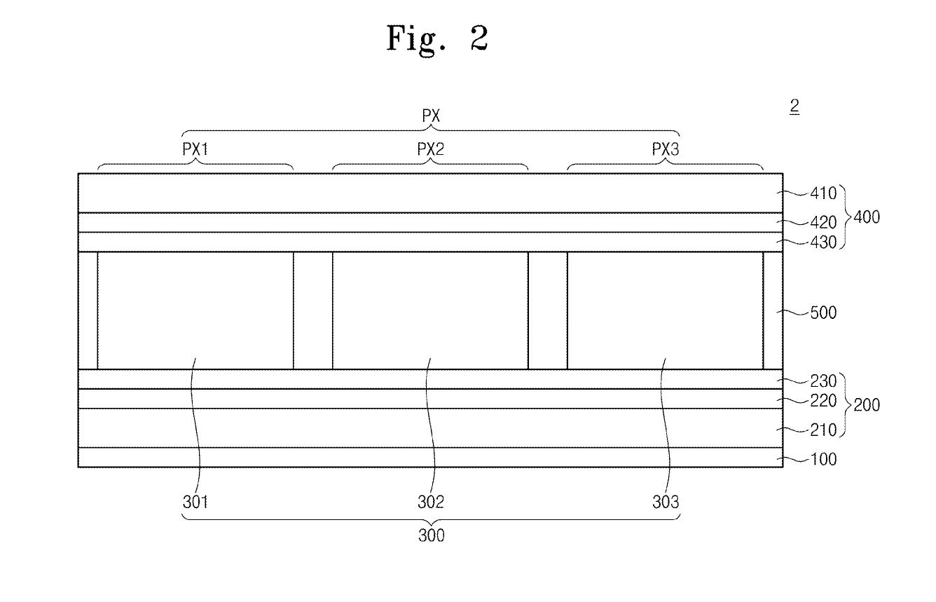

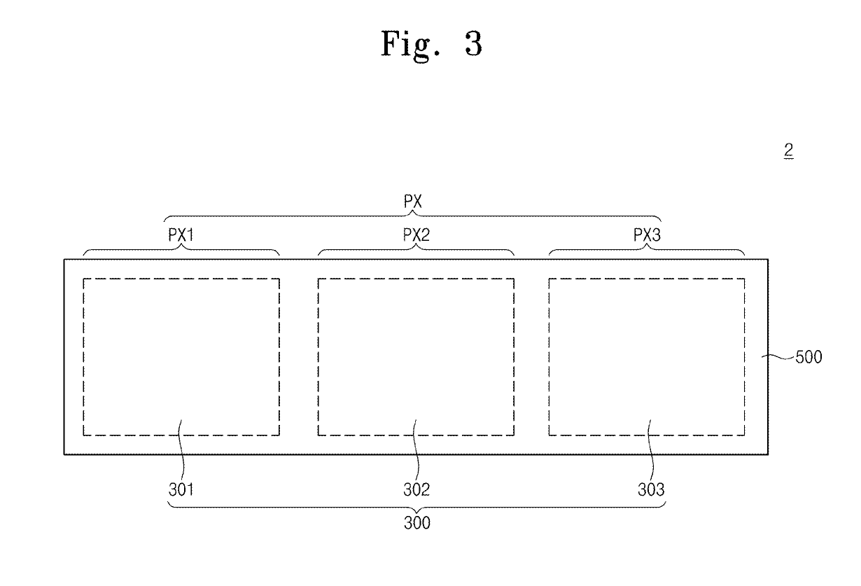

FIG. 2 is a sectional view of a liquid crystal display device according to other example embodiments of the inventive concept. FIG. 3 is a plan view of a liquid crystal display device according to other example embodiments of the inventive concept. For the sake of brevity, the elements and features of this example that are similar to those previously shown and described will not be described in much further detail.

Referring to FIGS. 2 and 3, a liquid crystal display device 2 may include the reflection plate 100, the lower substrate 200 on the reflection plate 100, the upper substrate 400 spaced apart from the lower substrate 200, a partition 500 provided on the lower substrate 200 to delimit pixels PX, and the liquid crystal layer 300 provided in the pixels PX. The lower substrate 200 may include the first substrate 210, the first electrode 220, and the first insulating layer 230 sequentially stacked on the reflection plate 100. The upper substrate 400 may include the second insulating layer 430, the second electrode 420, and the second substrate 410 sequentially stacked on the liquid crystal layer 300. The lower substrate 200 and the upper substrate 400 may be configured to have substantially the same technical features as those described with reference to FIG. 1.

The partition 500 may be interposed between the lower substrate 200 and the upper substrate 400. The partition 500 may be provided on the lower substrate 200 to surround the pixels PX and delimit the pixels PX. The pixel PX may be demarcated by the partition 500. In example embodiments, the pixel PX may include a first pixel PX1, a second pixel PX2, and a third pixel PX3 that are configured to display different colors from each other.

The liquid crystal layer 300 may be interposed between the first insulating layer 230 and the second insulating layer 430 and be provided in the pixel PX. The liquid crystal layer 300 may include the liquid crystal composition, which may include a liquid crystal and a coloring material dissolved therein. The coloring material may be the same coloring material as that described with reference to FIG. 1. The liquid crystal layer 300 may include a first liquid crystal layer 301 provided in the first pixel PX1, a second liquid crystal layer 302 provided in the second pixel PX2, and a third liquid crystal layer 303 provided in the third pixel PX3. The first liquid crystal layer 301, the second liquid crystal layer 302, and the third liquid crystal layer 303 may contain different coloring materials from each other, and thus, the first, second, and third pixels PX1, PX2, and PX3 may display different colors from each other. For example, the first liquid crystal layer 301 may include a yellow coloring material, the second liquid crystal layer 302 may include a cyan coloring material, and the third liquid crystal layer 303 may include a magenta coloring material. In other embodiments, the first liquid crystal layer 301 may include at least two of the yellow, magenta, and cyan coloring materials. The second liquid crystal layer 302 may include at least two of the yellow, magenta, and cyan coloring materials, but it may be configured to display a color different from that of the first liquid crystal layer 301. The third liquid crystal layer 303 may include at least two of the yellow, magenta, and cyan coloring materials, but it may be configured to display a color different from those of the first and second liquid crystal layers 301 and 302. Here, the first liquid crystal layer 301, the second liquid crystal layer 302, and the third liquid crystal layer 303 may be configured in such a way that composition or weight percentages of the coloring materials therein are different from each other. By using this difference, it is possible to control color coordinate, lightness, and saturation of colors to be displayed by the first, second, and third pixels PX1, PX2, and PX3.

According to example embodiments of the inventive concept, the coloring material may have high solubility and dispersion stability on the liquid crystal, and thus, it can be used for the liquid crystal layer 300. Further, the liquid crystal display device 2 can display various colors with low power consumption, without color filter.

According to example embodiments of the inventive concept, the liquid crystal layer of the liquid crystal display device may include the liquid crystal and the coloring material including at least one of yellow, magenta, and cyan coloring materials. The coloring material has high solubility and dispersion stability on the liquid crystal, and thus, it can be used for the liquid crystal layer. The liquid crystal display device may include, for example, the partition delimiting the first, second, and third pixels. The first liquid crystal layer may be provided in the first pixel, the second liquid crystal layer may be provided in the second pixel, and the third liquid crystal layer may be provided in the third pixel. The first, second, and third liquid crystal layers may be configured to contain different coloring materials from each other, and be configured in such a way that the first, second, and third pixels display different colors from each other. The kind, composition, and weight percentage of the coloring materials in the first, second, and third liquid crystal layers may be adjusted to control colors to be displayed by the first, second, and third pixels. The liquid crystal display device can display various colors with low power consumption, without color filter.

While example embodiments of the inventive concepts have been particularly shown and described, it will be understood by one of ordinary skill in the art that variations in form and detail may be made therein without departing from the spirit and scope of the attached claims.

What is claimed is:

1. A liquid crystal display device, comprising:
a lower substrate on a reflection plate;
an upper substrate spaced apart from and facing the lower substrate; and
a liquid crystal layer interposed between the lower substrate and the upper substrate,
wherein the liquid crystal layer comprises:
a liquid crystal; and
a coloring material including at least one of yellow, magenta, and cyan coloring materials that are represented by the following chemical formulas 1, 2, and 3, respectively, 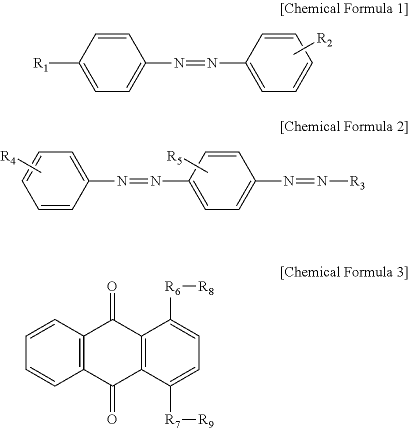
where R₁ is one selected from the group consisting of —N(CH₃)₂, —N(C₂H₅)₂, and —NR₂ (here, R is an alkyl chain having 1 to 5 carbon atoms),
R₂ is one selected from the group consisting of H, CH₃, C₂H₅, linear alkyl having 1 to 5 carbon atoms, branched alkyl having 1 to 5 carbon atoms, linear alkene having 1 to 5 carbon atoms, branched alkene having 1 to 5 carbon atoms, aromatic functional group having 1 to 3 benzene rings, and naphthalene,
R₃ is one selected from the group consisting of the following structural units: 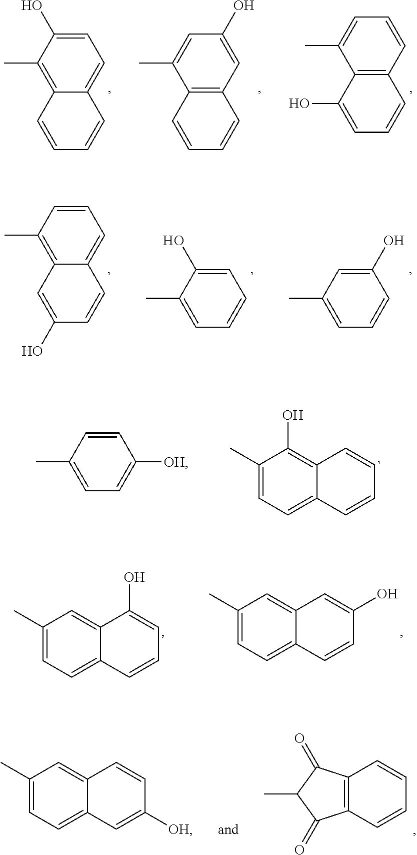
each of R₄ and R₅ is one selected from the group consisting of H, CH₃, C₂H₅, linear alkyl having 1 to 5 carbon atoms, branched alkyl having 1 to 5 carbon atoms, linear alkene having 1 to 5 carbon atoms, branched alkene having 1 to 5 carbon atoms, aromatic functional group having 1 to 3 benzene rings, and naphthalene,
each of R₆ and R₇ is one selected from the group consisting of O, S, Se, CH₂, NH, and COO, and
each of R₈ and R₉ is one selected from the group consisting of H, CH₃, C₂H₅, C₃H₈, C₄H₁₁, C₅H₁₄, linear alkyl having 6 to 10 carbon atoms, branched alkyl having 6 to 10 carbon atoms, linear alkene having 1 to 5 carbon atoms, branched alkene having 1 to 5 carbon atoms, aromatic functional group having 1 to 3 benzene rings, and naphthalene.

2. The liquid crystal display device of claim 1, further comprising a partition provided on the lower substrate to delimit a first pixel, a second pixel, and a third pixel,
wherein the liquid crystal layer comprises a first liquid crystal layer provided on the first pixel, a second liquid crystal layer provided on the second pixel, and a third liquid crystal layer provided on the third pixel.

3. The liquid crystal display device of claim 2, wherein the first pixel, the second pixel, and the third pixel are configured to display different colors from each other.

4. The liquid crystal display device of claim 3, wherein the first liquid crystal layer comprises the yellow coloring material, the second liquid crystal layer comprises the magenta coloring material, and the third liquid crystal layer comprises the cyan coloring material.

5. The liquid crystal display device of claim 3, wherein the first liquid crystal layer comprises at least two of the yellow, magenta, and cyan coloring materials,
the second liquid crystal layer comprises at least two of the yellow, magenta, and cyan coloring materials, whose composition is different from that of the first liquid crystal layer, and
the third liquid crystal layer comprises at least two of the yellow, magenta, and cyan coloring materials, whose composition is different from that of the first liquid crystal layer.

6. The liquid crystal display device of claim 3, wherein the first liquid crystal layer comprises at least two of the yellow, magenta, and cyan coloring materials,
the second liquid crystal layer comprises at least two of the yellow, magenta, and cyan coloring materials, whose weight-percent ratio is different from that of the first liquid crystal layer, and
the third liquid crystal layer comprises at least two of the yellow, magenta, and cyan coloring materials, whose weight-percent ratio is different from that of the second liquid crystal layer.

7. The liquid crystal display device of claim 1, wherein the coloring material is contained to have a weight percent of 0.01 to 10 wt % with respect to the liquid crystal.

8. A liquid crystal display device, comprising a coloring material including at least one of a yellow coloring material represented by the following chemical formula 1, a magenta coloring material represented by the following chemical formula 2, and a cyan coloring material represented by the following chemical formula 3, 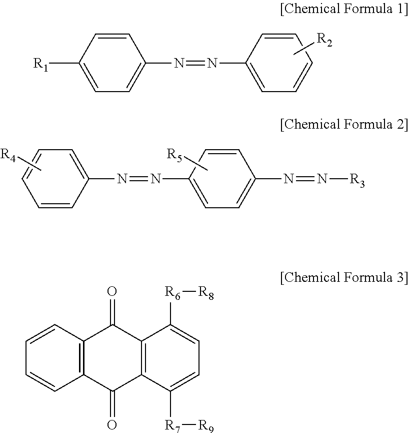
where R₁ is one selected from the group consisting of —N(CH₃)₂, —N(C₂H₅)₂, and —NR₂ (here, R is an alkyl chain having 1 to 5 carbon atoms),
R₂ is one selected from the group consisting of H, CH₃, C₂H₅, linear alkyl having 1 to 5 carbon atoms, branched alkyl having 1 to 5 carbon atoms, linear alkene having 1 to 5 carbon atoms, branched alkene having 1 to 5 carbon atoms, aromatic functional group having 1 to 3 benzene rings, and naphthalene,
R₃ is one selected from the group consisting of the following structural units: 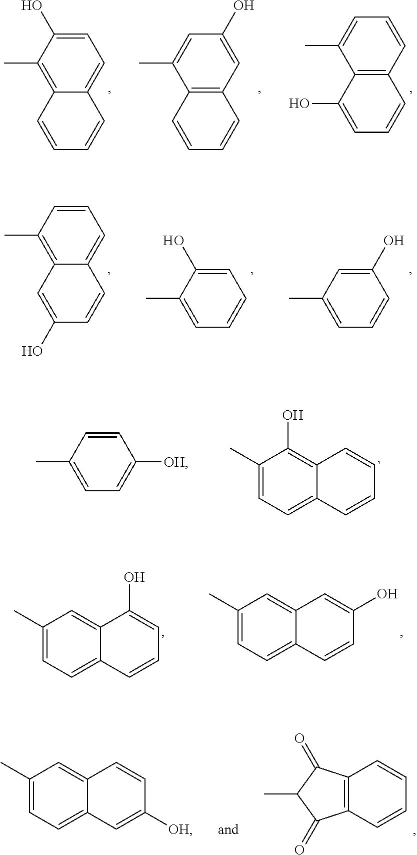
each of R₄ and R₅ is one selected from the group consisting of H, CH₃, C₂H₅, linear alkyl having 1 to 5 carbon atoms, branched alkyl having 1 to 5 carbon atoms, linear alkene having 1 to 5 carbon atoms, branched alkene having 1 to 5 carbon atoms, aromatic functional group having 1 to 3 benzene rings, and naphthalene,
each of R₆ and R₇ is one selected from the group consisting of O, S, Se, CH₂, NH, and COO, and
each of R₈ and R₉ is one selected from the group consisting of H, CH₃, C₂H₅, C₃H₈, C₄H₁₁, C₅H₁₄, linear alkyl having 6 to 10 carbon atoms, branched alkyl having 6 to 10 carbon atoms, linear alkene having 1 to 5 carbon atoms, branched alkene having 1 to 5 carbon atoms, aromatic functional group having 1 to 3 benzene rings, and naphthalene.

9. The liquid crystal display device of claim 8, further comprising a liquid crystal that is contained to have a weight percent of 0.01 to 10 wt % with respect to the liquid crystal.
